(19) United States
(12) Patent Application Publication
(10) Pub. No.: US 2008/0108721 A1
(43) Pub. Date: May 8, 2008

(54) Photocurable pressure-sensitive adhesive composition including acrylic binder resin, adhesive tape using the same, and associated methods

(76) Inventors: Kyoung Jin Ha, Seoul (KR); Chang Bum Chung, Yongin-si (KR); Wan Jung Kim, Suwon-si (KR); Yong Ha Hwang, Bucheon-si (KR); Ki Sung Jung, Uiwang-si (KR); Yong Woo Hong, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 11/976,583

(22) Filed: Oct. 25, 2007

(30) Foreign Application Priority Data
Oct. 26, 2006 (KR) 10-2006-0104448

(51) Int. Cl. C08F 20/06; C08F 2/50

(52) U.S. Cl. 522/33; 522/68; 522/89

(57) ABSTRACT

A photocurable pressure-sensitive adhesive composition includes an acrylic binder resin including a cellulose compound and an acrylic monomer, an acrylate oligomer compound, a curing agent, and a photoinitiator.

### BACKGROUND OF THE INVENTION

1. Field of the Invention

Example embodiments relate to a photocurable pressure-sensitive adhesive composition including an acrylic binder resin, an adhesive tape using the same, and associated methods. More particularly, example embodiments relate to a photocurable pressure-sensitive adhesive composition including an acrylic binder resin which may provide excellent initial adhesivity, high peel strength even when implemented at a relatively low molecular weight of about 150,000 to 200,000, excellent photocurability, and good change in peel strength, i.e., a low peel strength after photocuring, and to an adhesive tape using the same and associated methods.

2. Description of the Related Art

Ultraviolet (UV) light curing technologies were first applied in the field of paint coating and the use thereof has continuously increased. In a light source used for UV-curing, near-UV light having a wavelength ranging from 200 to 400 nm is commonly used. As the light source, a high-pressure mercury lamp or a UV fluorescent lamp may be used.

In a polymer adhesive, functional groups may provide intramolecular crosslinks and may improve adhesivity due to reactions with various other functional groups. The mechanism by which the functional groups improve adhesivity has not been clearly established, but it has been shown that the functional groups can increase adhesivity by strengthening the initial adhesion of the adhesive on an adherend and then forming hydrogen bonds or secondary bonds between the adhesive and the adherend.

A photocurable pressure-sensitive adhesive composition, which can be applied to single-sheet posters, electronic materials, optical materials and the like, which has excellent adhesivity and may not contaminate a surface even when it is repeatedly attached and detached, may include a photocurable silicon-modified acrylate having a main chain including polydimethylsiloxane. However, for such an adhesive composition, the substrate on which the adhesive composition is to be applied is limited to unreactive glass, plastic or the like. Further, the adhesive composition may have limitations in that the adhesive composition may be expensive and may exhibit poor material properties, e.g., poor cohesion and adhesivity. Such poor material properties may render the composition less desirable for a film for dicing or die bonding in a semiconductor manufacturing environment.

Adhesivity with respect to a semiconductor die may be reduced by applying an acrylic adhesive composed of a copolymer of butyl acrylate and acrylic acid on a thermally shrinkable film of polyethylene terephthalate, and then heating the shrinkable film coated with the acrylic adhesive so as to reduce the area in which dies are in contact with the acrylic adhesive. However, such an approach may require a large amount of UV energy, e.g., of 800 mJ/cm² to 1200 mJ/cm². Furthermore, such a pressure-sensitive adhesive composition may not be optimal for a dicing adhesive tape or a die bonding adhesive tape because it may have a high peel strength after UV curing, whereas such tapes should provide low peel strength after UV curing for a die pick-up process.

For a photocurable adhesive composition for dicing a semiconductor substrate, improving, i.e., lowering, peel strength after UV curing may be effected by curing hydroxyl groups of acrylic polyol and polyisocyanate. However, in an adhesive composition for dicing prepared using this technology, the substrate on which the adhesive is to be adhered may be limited to a wafer, and the peel strength thereof may be undesirably increased after UV curing when the adhesive composition is applied to a die bonding film having an organic substrate or base film.

A pressure-sensitive adhesive composition for a dicing tape may include a ternary copolymer of butyl acrylate, acrylic acid and methyl methacrylate, in combination with an acrylic photocurable monomer and a photoinitiator. However, in such a pressure-sensitive adhesive composition, acrylic acid may be introduced into a binder polymer of an adhesive layer disposed adjacent thereto, e.g., a die bonding film adhesive layer. As a result of the introduction of the acrylic acid into the binder polymer, the adhesivity of the pressure-sensitive adhesive composition to the die bonding film may be increased, which may result in it sticking to the die bonding film. As a result, die pick-up yields, which may depend upon the proper release of the pressure-sensitive adhesive composition from the die bonding film, may be reduced.

An adhesive composition may be formed using a base resin having a molecular weight ranging from 300,000 to 700,000. However, in this case, the productivity of a process used to form the adhesive composition may be greatly decrease because it may take a lot of time to synthesize a copolymer having such a high molecular weight.

Thus, it is apparent that a need exists for a photocurable pressure-sensitive adhesive composition having excellent photocurability, which is easily produced.

### SUMMARY OF THE INVENTION

Embodiments are therefore directed to a photocurable pressure-sensitive adhesive composition including an acrylic binder resin, an adhesive tape using the same, and associated methods, which substantially overcome one or more of the problems due to the limitations and disadvantages of the related art.

It is therefore a feature of an embodiment to provide a photocurable pressure-sensitive adhesive composition that may exhibit excellent initial adhesivity.

It is therefore another feature of an embodiment to provide a photocurable pressure-sensitive adhesive composition that may exhibit excellent photocurability and good change in peel strength after photocuring.

At least one of the above and other features and advantages may be realized by providing a photocurable pressure-sensitive adhesive composition, including an acrylic binder resin including a cellulose compound and an acrylic monomer, an acrylate oligomer compound, a curing agent, and a photoinitiator.

The composition may include, based on solid content, about 35% to about 65% by weight of the acrylic binder resin, about 25% to about 60% by weight of the acrylate oligomer compound, about 1% to about 20% by weight of the curing agent, and about 1% to about 5% by weight of the photoinitiator.

The acrylic binder resin may be a copolymer of the cellulose compound and the acrylic monomer, the acrylic binder resin may include about 5% to about 20% by weight of the cellulose compound, based on the weight of the acrylic binder resin, and the acrylic binder resin may include about 80% to about 95% by weight of the acrylic monomer, based on the weight of the acrylic binder resin.

The cellulose compound may include one or more of cellulose acetate butyrate, cellulose acetate propionate, carboxymethyl cellulose, hydroxymethyl cellulose, triacetyl cellulose, hydroxyethyl cellulose, hydroxypropyl cellulose, hydroxypropyl methyl cellulose, ethane cellulose, or nitrocellulose.

The cellulose compound may have an acetyl amount of about 2% to about 30% by weight.

The cellulose compound may have a hydroxy number of about 20 to about 150, a glass transition temperature of about 85° C. to about 130° C., and a weight-average molecular weight of about 1,200 to about 70,000.

The cellulose compound may include cellulose acetate butyrate, and the cellulose acetate butyrate may have a butyryl amount of about 17% to about 53% by weight of the cellulose acetate butyrate.

The acrylic monomer may include one or more of a carboxylic monomer, a hydroxy monomer, a functional monomer, a soft acrylic monomer, or a hard acrylic monomer.

The acrylic monomer may include (1) the carboxylic monomer, and the carboxylic monomer may include one or more of methacrylic acid, itaconic acid, maleic acid, or fumaric acid, or (2) the hydroxy monomer, and the hydroxy monomer may include one or more of 2-hydroxyethyl methacrylate, hydroxyethyl acrylate, hydroxybutyl acrylate, hydroxypropyl (meth)acrylate, or vinyl caprolactam, or (3) the functional monomer, and the functional monomer may include one or more of dimethylaminoethyl methacrylate, t-butylaminoethyl methacrylate, diethylaminoethyl methacrylate, or glycidyl methacrylate, or (4) the soft acrylic monomer, and the soft acrylic monomer may include one or more of 2-ethylhexyl methacrylate, lauryl methacrylate, methyl acrylate, ethyl acrylate, n-butyl acrylate, isobutyl acrylate, 2-ethylhexyl acrylate, or octadecyl methacrylate, or (5) the hard acrylic monomer, and the hard acrylic monomer may include one or more of methyl methacrylate, styrene, cyclohexyl methacrylate, methacrylate, isobornyl methacrylate, glycidyl methacrylate, n-butyl methacrylate, isobutyl methacrylate, t-butyl methacrylate, vinyl chloride, vinyl acetate, or acrylonitrile.

The acrylic binder resin may have a hydroxy number of about 20 about 40, an acid number of about 60 to about 95, a glass transition temperature of about −70° C. to about −50° C., and a weight-average molecular weight of about 150,000 to about 200,000.

The acrylate oligomer compound may include one or more of a urethane acrylate oligomer and an epoxy acrylate oligomer.

The acrylate oligomer compound may include (1) the urethane acrylate oligomer, and the urethane acrylate oligomer may have a weight-average molecular weight of about 500 to about 5000 and a functional group number of about 3 to about 8, or (2) the epoxy acrylate oligomer, and the epoxy acrylate oligomer may have a weight-average molecular weight of about 500 or less and a functional group number of 1 to about 4.

The curing agent may include one or more of polyisocyanate and a multi-functional epoxy compound.

The curing agent may include (1) the polyisocyanate, and the polyisocyanate may include one or more of 2,4-trilene diisocyanate, 2,6-trilene diisocyanate, hydrogenated trilene diisocyanate, 1,3-xylene diisocyanate, 1,4-xylene diisocyanate, diphenyl methane-4,4-diisocyanate, 1,3-bisisocyanatomethyl cyclohexane, tetramethyl xylene diisocyanate, 1,5-naphthalene diisocyanate, 2,2,4-trimethyl hexamethylene diisocyanate, 2,4,4-trimethyl hexamethylene diisocyanate, a trilene diisocyanate adduct of trimethylol propane, a xylene diisocyanate adduct of trimethylol propane, triphenylmethane triisocyanate, or methylene bistriisocyanate, or (2) the multi-functional epoxy compound, and the multi-functional epoxy compound may include one or more of a bisphenol A-epichlorohydrin type epoxy resin, an epoxy compound, an azide compound, or a melamine compound.

The multi-functional epoxy compound may include (1) the epoxy compound, and the epoxy compound may include one or more of ethylene glycol diglycidyl ether, polyethylene glycol diglycidyl ether, glycerin diglycidyl ether, glycerin triglycidyl ether, 1,6-hexanediol diglycidyl ether, trimethylolpropane triglycidyl ether, sorbitol polyglycidyl ether, polyglycerol polyglycidyl ether, pentaerythritol polyglycidyl ether, or diglycerol polyglycidyl ether, or (2) the azide compound, and the azide compound may include one or more of tetramethylolmethane-tri-β-aziridinylpropionate, trimethylolpropane-tri-β-aziridinylpropionate, N,N′-diphenylmethane-4,4′-biscarboxyamide, N,N′-hexamethylene-1,6-biscarboxyamide, or N,N,N′,N′-tetrakis(oxylaurylmethyl)-1,3-benzenedimethane amine, or (3) the melamine compound, and the melamine compound may include one or more of hexamethoxymethyl melamine, hexaethoxymethyl melamine, hexapropoxymethyl melamine, hexabutoxymethyl melamine, hexapentyloxymethyl melamine, or hexahexyloxymethyl melamine.

The curing agent may include about 5% to about 15% by weight of polyisocyanate and about 1% to about 5% by weight of a multi-functional epoxy compound, based on the weight of the curing agent.

The photoinitiator may include a mixture of an alpha-hydroxy ketone type compound and a benzylketal type compound.

The alpha-hydroxy ketone type compound may have a melting point of about 45° C. to about 49° C., and the benzylketal type compound may have a melting point of about 64° C. to about 67° C.

At least one of the above and other features and advantages may be realized by providing an adhesive tape including a photocurable pressure-sensitive composition as described herein. The adhesive tape may be incorporated into a dicing film, a die bonding film, or a dicing die bonding film.

### BRIEF DESCRIPTION OF THE DRAWINGS

The above and other features and advantages will become more apparent to those of ordinary skill in the art by describing in detail example embodiments with reference to the attached drawings, in which:

FIG. 1 illustrates a table of components used for preparation of acrylic binder resins;

FIG. 2 illustrates a table of components used for preparation of photocurable pressure-sensitive adhesive compositions;

FIG. 3 illustrates a table of results of measurement of initial adhesivity of photocurable pressure-sensitive adhesive compositions;

FIG. 4 illustrates a table of results of measurement of tackiness of photocurable pressure-sensitive adhesive compositions; and

FIGS. 5A and 5B illustrate stages in a method of packaging a semiconductor device according to an embodiment.

### DETAILED DESCRIPTION OF THE INVENTION

Korean Patent Application No. 10-2006-0104448, filed on Oct. 26, 2006, in the Korean Intellectual Property Office, and entitled: “Photocurable Pressure-Sensitive Adhesive Composition Comprising Acrylic Binder Resin and Adhesive Tape Using the Same,” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

In the figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

As used herein, the expressions “at least one,” “one or more,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C” and “A, B, and/or C” includes the following meanings: A alone; B alone; C alone; both A and B together; both A and C together; both B and C together; and all three of A, B, and C together. Further, these expressions are open-ended, unless expressly designated to the contrary by their combination with the term “consisting of” For example, the expression “at least one of A, B, and C” may also include an nth member, where n is greater than 3, whereas the expression “at least one selected from the group consisting of A, B, and C” does not.

As used herein, the expression “or” is not an “exclusive or” unless it is used in conjunction with the term “either.” For example, the expression “A, B, or C” includes A alone; B alone; C alone; both A and B together; both A and C together; both B and C together; and all three of A, B and, C together, whereas the expression “either A, B, or C” means one of A alone, B alone, and C alone, and does not mean any of both A and B together; both A and C together; both B and C together; and all three of A, B and C together.

As used herein, the term photocurable includes irradiation with light, e.g., UV light, and/or other radiation such as electrons, e.g., an electron beam.

As used herein, “peel strength” is a characteristic of an adhesive with respect to two adherends that are joined by the adhesive. A high peel strength indicates that the two adherends are relatively strongly bonded under the testing conditions. Conversely, a low peel strength indicates that the two adherends are relatively weakly bonded under the testing conditions.

As used herein, molecular weight refers to weight average molecular weight, unless specified otherwise.

A dicing process is a process of cutting a semiconductor wafer into individual semiconductor devices, i.e., dies or chips. Following the dicing process, a pick-up process and die attaching process may be sequentially performed. An adhesive film and a pressure-sensitive adhesive (PSA) layer may be used to form a dicing die bonding film for use in semiconductor manufacturing. The dicing die bonding film is an integrated film used for both dicing and die bonding, i.e., die attach. The PSA layer of the dicing die bonding film may be formed using a photocurable pressure-sensitive adhesive composition according to an embodiment.

It will be appreciated that the photocurable pressure-sensitive adhesive composition described herein may be also employed with a dicing film alone, i.e., without an adhesive film thereon, or in more general applications such as an adhesive tape.

In use, a pick-up process may require that a die laminated with the adhesive layer of the dicing die bonding film be completely picked up, i.e., removed from the PSA layer, after dicing. Further, in order for the individual dies to separate from the underlying PSA layer during pick-up, it may be desirable for the PSA layer to exhibit a changeable adhesion, e.g., a high adhesion suitable for the dicing process and a low adhesion suitable for the pick-up process. Such a change in adhesion may be effected by curing, e.g., irradiation with light such as UV light. Thus, it may be desirable for the PSA layer to exhibit a significantly lower adhesion after curing, such that the curing process effects a reduction in peel strength of the PSA layer and the peel strength is reduced by an amount sufficient to enable successful die pick-up rates. Accordingly, as the difference in peel strength between before and after curing increases, the die pick-up success rate may also increase.

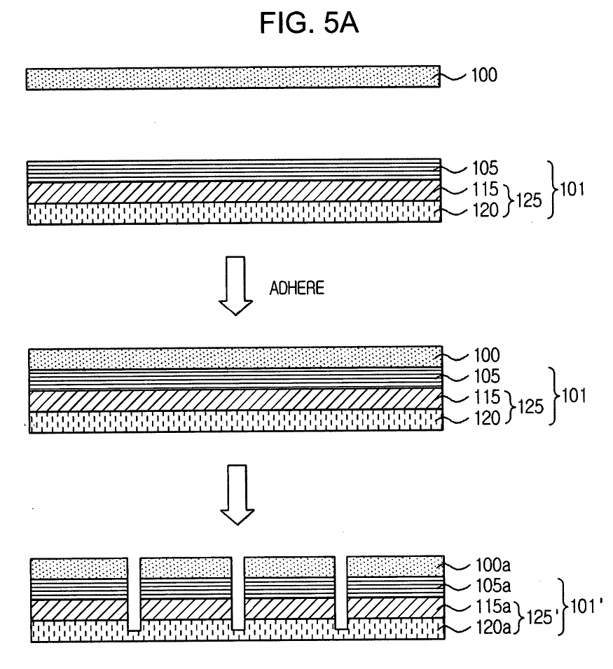

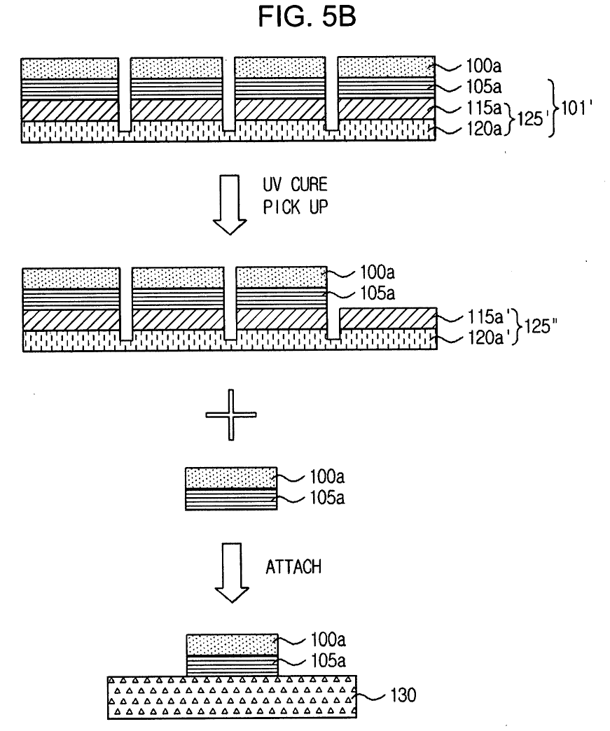

FIGS. 5A and 5B illustrate stages in an example method of packaging a semiconductor device according to an embodiment, wherein a semiconductor wafer is diced and an individual semiconductor device, i.e., a die, is attached to a substrate using a dicing die bonding film. For clarity, the last stage illustrated in FIG. 5A is repeated at the top of FIG. 5B.

Referring to FIGS. 5A and 5B, a semiconductor wafer 100 may have a plurality of devices fabricated thereon, e.g., memory devices, microprocessors, etc. In order to package the devices, it may be desirable to separate the semiconductor wafer 100 along scribe lines so as to form a plurality of dies 100a. This dicing process may involve laminating the entire, un-diced wafer 100 with a dicing die bonding film 101 that includes a dicing film 125 and an intermediate adhesive layer 105.

The dicing film 125 may include a PSA layer 115 and a base film 120. The PSA layer 115 of the dicing die bonding film 101 may be formed using a photocurable pressure-sensitive adhesive composition according to an embodiment. The PSA layer 115 may be, e.g., a UV-curing film.

The base film 120 may be, e.g., a polyolefin film such as polyethylene terephthalate (PET) film. In an implementation, the dicing film 125 may be fabricated by laminating the PSA layer 115 with the base film 120.

The dicing die bonding film 101 may be attached to the semiconductor wafer 100 at the adhesive layer 105, and the PSA layer 115 may face and be attached to the adhesive layer 105.

As described above, a wafer assembly may be formed having the un-diced wafer 100 bonded to the dicing die bonding film 101 that includes the adhesive layer 105. A dicing process may then be performed to separate the wafer 100 into a plurality of dies 100a. The dicing process may also separate the adhesive layer 105 into parts 105a corresponding to the individual dies 100a, as indicated by the separated adhesive layer 105a of the post-dicing dicing die bonding film 101′. Similarly, the dicing film 125 may be partially separated to form dicing film 125′, which has the PSA layer 115 separated into parts 115a and the base film 120 partially separated into parts 120a. Throughout the dicing process, the wafer 100/dies 100a may remain adhered to the dicing die bonding film 101/101′.

Referring to FIG. 5B, an individual die 100a may be removed from the dicing die bonding film 101′. This process may be enabled by exposing the assembly to UV light, which may cure the PSA layer 115a to yield a cured PSA layer 115a′ having a reduced level of adhesion. In particular, the cured PSA layer 115a′ may have a significantly lower adhesion to the diced adhesive layer 105a, such that, during pick up of the individual die 100a, the diced adhesive layer 105a remains adhered to the individual die 100a and releases from the cured PSA layer 115a′. Thus, the pick-up process may remove the individual die 100a and its associated diced adhesive layer 105a, which may then be mounted to a substrate 130, with the diced adhesive layer 105a facing and in contact with the substrate 130, such that the individual die 100a is attached to the substrate 130. Further processes, e.g., wiring, encapsulation, etc., may also be performed.

The PSA layer 115 may be formed using a photocurable pressure-sensitive adhesive composition according to an embodiment, details of which will now be described. In an embodiment, the photocurable pressure-sensitive adhesive composition may include an acrylic binder resin including a cellulose compound and an acrylic monomer, an acrylate oligomer compound, a curing agent, and a photoinitiator.

Acrylic Binder Resin

The acrylic binder resin may include about 5% to about 20% by weight, preferably about 7% to about 15% by weight, of the cellulose compound, and about 80% to about 95% by weight, preferably about 85% to about 93% by weight, of the acrylic monomer, based on the weight of the acrylic binder resin.

Maintaining the amount of the cellulose compound at or above about 5% by weight may improve the extent of reduction in peel strength upon photocuring, such that the change (reduction) in peel strength may be sufficient to enable good pick-up yields. Maintaining the amount of the cellulose compound at or below about 20% by weight may result in improved adherence of the composition to a polyolefin film that may be used as a dicing base film.

The cellulose compound may include one or more of cellulose acetate butyrate, cellulose acetate propionate, carboxymethyl cellulose, hydroxymethyl cellulose, triacetyl cellulose, hydroxyethyl cellulose, hydroxypropyl cellulose, hydroxypropyl methyl cellulose, ethane cellulose, or nitrocellulose.

The cellulose compound may have an acetyl amount of about 2% to about 30% by weight, a melting point of about 127° C. to about 142° C., a hydroxy number of about 20 to about 150, a glass transition temperature of about 85° C. to about 130° C., and a weight-average molecular weight of about 1,200 to about 70,000. The amount of butyryl included in the cellulose acetate butyrate may be about 17% to about 53% by weight, based on the weight of the cellulose acetate butyrate.

The acrylic monomer included in the acrylic binder resin may include one or more of a carboxylic monomer, a hydroxy monomer, a functional monomer, a soft acrylic monomer, or a hard acrylic monomer.

The carboxylic monomer may include one or more of methacrylic acid, itaconic acid, maleic acid, or fumaric acid.

The hydroxy monomer may include one or more of 2-hydroxyethyl methacrylate, hydroxyethyl acrylate, hydroxybutyl acrylate, hydroxypropyl (meth)acrylate, or vinyl caprolactam.

The functional monomer may include one or more of dimethylaminoethyl methacrylate, t-butylaminoethyl methacrylate, diethylaminoethyl methacrylate, or glycidyl methacrylate.

The soft acrylic monomer may include one or more of 2-ethylhexyl methacrylate, lauryl methacrylate, methyl acrylate, ethyl acrylate, n-butyl acrylate, isobutyl acrylate, 2-ethylhexyl acrylate, or octadecyl methacrylate.

The hard acrylic monomer may include one or more of methyl methacrylate, styrene, cyclohexyl methacrylate, methacrylate, isobornyl methacrylate, glycidyl methacrylate, n-butyl methacrylate, isobutyl methacrylate, t-butyl methacrylate, vinyl chloride, vinyl acetate, or acrylonitrile.

The acrylic binder resin may have a hydroxy number of about 20 to about 40, an acid number of about 60 to about 95, a weight-average molecular weight of about 150,000 to about 200,000, and a glass transition temperature of about −70° C. to about −50° C., preferably about −70° C. to about −60° C., which may provide a desirable level of initial adhesivity after thermal curing.

Maintaining the glass transition temperature at or below about −50° C. may help ensure sufficient initial adhesivity so that, when dicing of a wafer is performed, the acrylic binder resin does not separate from a ring frame by maintaining a sufficient level of adhesion between the acrylic binder resin and the ring frame. Further, maintaining the glass transition temperature at or below about −50° C. may help ensure that dies do not scatter due to too low of an adhesion between the acrylic binder resin and the wafer.

The photocurable pressure-sensitive adhesive composition according to example embodiments may include about 35% to about 65% by weight of the acrylic binder resin, about 25% to about 60% by weight of the acrylate oligomer compound, about 1% to about 20% by weight of the curing agent, and about 1% to about 5% by weight of the photoinitiator, based on the solid content of the composition.

Generally, an acrylic binder resin may exhibit a high tackiness and a low mechanical strength, and may be undesirably transferred to an adherend when it has too low a molecular weight. On the other hand, the adhesivity of acrylic binder resin may be decreased and the cohesion thereof increased as its molecular weight is increased. In an implementation, a photocurable pressure-sensitive adhesive composition of example embodiments may include an acrylic binder resin of acrylic polyol having a molecular weight of about 150,000 to about 200,000, a functional monomer and a cross-linking agent, and thus the tackiness and mechanical strength of the composition may be improved.

In the acrylic binder resin that is used in the photocurable pressure-sensitive adhesive composition of example embodiments, a new cross-linked polymer may be formed due to the curing of an acrylate oligomer compound, e.g., after photocuring, so that the adhesivity thereof is decreased. That is, the acrylic binder resin may function to cause an effective interaction when the new cross-linked polymer is formed on the interface of a cellulose compound, such that the composition may exhibit a good change in peel strength after photocuring.

Maintaining the amount of the acrylic binder resin at or above about 35% by weight may help ensure good coatability of the resin on the surface of a PET substrate when a transfer coating method is used, such that the acrylic binder resin is applied on the surface of the PET in a state in which surface morphology is uniform. Maintaining the amount thereof at or below about 65% by weight may help ensure that the change in peel strength before and after curing is large enough to provide good die pick-up yields, i.e., to improve the success rate of die pick-up after curing by allowing the die to be released from the base film.

Acrylate Oligomer Compound

The acrylate oligomer compound used in the photocurable pressure-sensitive adhesive composition of example embodiments may include a urethane acrylate oligomer, an epoxy acrylate oligomer, or a mixture thereof. When a mixture of the urethane acrylate oligomer and epoxy acrylate oligomer is used as the acrylate oligomer compound, the amount of the urethane acrylate oligomer may be about 70% to about 90% by weight, and the amount of the epoxy acrylate oligomer may be about 10% to about 30% by weight, based on the total amount of the acrylate oligomer compound.

The urethane acrylate oligomer may have a weight-average molecular weight of about 500 to about 5,000 and a functional group number of about 3 to about 8. The epoxy acrylate oligomer may have a weight-average molecular weight of about 500 or less and a functional group number of 1 to about 4.

The acrylate oligomer compound may be a photocurable material, and may be mixed with the acrylic binder resin. Before photocuring, the acrylate oligomer compound may have a tacky property, such that the acrylate oligomer compound holds a wafer on one side and a die bonding film on another side, and thus may be advantageous in a cutting process. Upon photocuring, a free-radical reaction may occur in the acrylate oligomer compound, such that the acrylate oligomer compound decreases the surface energy of the adhesive composition layer, which may improve the success rate of die pick-up due to decreased tackiness of the adhesive composition layer.

Maintaining the amount of the acrylate oligomer compound at or above about 25% by weight may help ensure that the peel strength of the acrylate oligomer compound with respect to a diced wafer after photocuring is sufficiently decreased, which may improve the success rate of the die pick-up process. Maintaining the amount thereof at or below about 60% by weight may help ensure that the adhesion of the acrylate oligomer compound to a base film remains good after photocuring.

Curing Agent

The curing agent used in the photocurable pressure-sensitive adhesive composition of example embodiments may include polyisocyanate, a multi-functional epoxy compound, or a mixture thereof. The amount of the curing agent may be about 1% to about 20% by weight, based on the total amount of the photocurable pressure-sensitive adhesive composition. In an implementation, the amount of curing agent may be about 2% to about 8% by weight, based on the total amount of the photocurable pressure-sensitive adhesive composition. When a mixture of a polyisocyanate and a multi-functional epoxy compound is used as the curing agent, the amount of polyisocyanate may be about 5% to about 15% by weight and the amount of multi-functional epoxy compound may be about 1% to about 5% by weight, based on the total amount of the photocurable pressure-sensitive adhesive composition.

The polyisocyanate may include one or more of 2,4-trilene diisocyanate, 2,6-trilene diisocyanate, hydrogenated trilene diisocyanate, 1,3-xylene diisocyanate, 1,4-xylene diisocyanate, diphenyl methane-4,4-diisocyanate, 1,3-bisisocyanatomethyl cyclohexane, tetramethyl xylene diisocyanate, 1,5-naphthalene diisocyanate, 2,2,4-trimethyl hexamethylene diisocyanate, 2,4,4-trimethyl hexamethylene diisocyanate, a trilene diisocyanate adduct of trimethylol propane, a xylene diisocyanate adduct of trimethylol propane, triphenylmethane triisocyanate, or methylene bis(triisocyanate).

The multi-functional epoxy compound may include one or more of a bisphenol A-epichlorohydrin type epoxy resin, an epoxy compound, an azide compound, or a melamine compound.

The bisphenol A-epichlorohydrin type epoxy resin may be an epoxy resin in which the terminal ends of a poly bisphenol A-epichlorohydrin structure are treated with glycidyl groups, and may include low-viscosity, medium-viscosity, and high-viscosity bisphenol A-epichlorohydrin epoxy resin. The epoxy compound may include one or more of ethylene glycol diglycidyl ether, polyethylene glycol diglycidyl ether, glycerin diglycidyl ether, glycerin triglycidyl ether, 1,6-hexanediol diglycidyl ether, trimethylolpropane triglycidyl ether, sorbitol polyglycidyl ether, polyglycerol polyglycidyl ether, pentaerythritol polyglycidyl ether, or diglycerol polyglycidyl ether.

The azide compound may include one or more of tetramethylolmethane-tri-β-aziridinylpropionate, trimethylolpropane-tri-β-aziridinylpropionate, N,N′-diphenylmethane-4,4′-biscarboxyamide, N,N′-hexamethylene-1,6-biscarboxyamide or N,N,N′,N′-tetrakis(oxylaurylmethyl)-1,3-benzenedimethane anine.

The melamine compound may include one or more of hexamethoxymethyl melamine, hexaethoxymethyl melamine, hexapropoxymethyl melamine, hexabutoxymethyl melamine, hexapentyloxymethyl melamine, or hexahexyloxymethyl melamine.

The curing agent may impart to the acrylic binder resin a suitably low peel strength after photocuring. The curing agent may form a coated film having adhesivity to a base film, and may be blended with the acrylic binder resin to provide the acrylic binder resin with high cohesion.

Maintaining the amount of the curing agent at or above about 1% by weight may increase the adhesivity to a base polyolefin film, which may reduce or eliminate the transfer of the adhesive film to a die during the die pick-up process after photocuring. Maintaining the amount thereof at or below about 20% by weight may avoid having uncured portions of the curing agent remaining. If too much curing agent is used in a product combined with a die bonding film, adhesion may be undesirably increased, and thus the success rate of pick-up after UV curing may be decreased.

Photoinitiator

The photoinitiator included in the photocurable pressure-sensitive composition of example embodiments may include a mixture of an alpha-hydroxy ketone type compound and a benzylketal type compound. The alpha-hydroxy ketone type compound may have a melting point of about 45° C. to about 49° C., and the benzylketal type compound may have a melting point of about 64° C. to about 67° C.

The photoinitiator may be activated using light, e.g., UV light, and/or other radiation such as electrons, e.g., an electron beam. Where the acrylate oligomer is a urethane acrylate having a carbon-carbon double bond, the activation of the photoinitiator may function to promote a free radical reaction.

Maintaining the amount of the photoinitiator at or above about 1% by weight may help ensure effective photocurability, so that the tackiness of an adhesive layer may be sufficiently decreased by photocuring, thus reducing the tackiness thereof after photocuring and improving die pick-up yields during the pick-up process. Maintaining the amount of photoinitiator at or below about 5% by weight may help ensure that most or all of the photoinitiator participates in the reaction at the time of the ultraviolet curing. This may also reduce odors arising from the photoinitiator, improving the quality of the workplace.

Another aspect of example embodiments provides an adhesive tape including the photocurable pressure-sensitive adhesive composition. The adhesive tape may be used for dicing films, die bonding films, dicing die bonding films, etc.

The adhesive tape of example embodiments may exhibit excellent initial adhesivity, and may exhibit a good change, i.e., lowering, in peel strength upon photocuring, e.g., a change in the adhesive tape upon photocuring action in which a high surface energy of 35 mN/m before photocuring is reduced to a low surface energy of 25 mN/m after photocuring. Therefore, the adhesive tape may be useful for dicing, die bonding, etc.

The following Examples and Comparative Examples are provided in order to set forth particular details of one or more example embodiments. However, it will be understood that example embodiments are not limited to the particular details described in the Examples and Comparative Examples.

### EXAMPLE 1

### Preparation of Acrylic Binder Resin

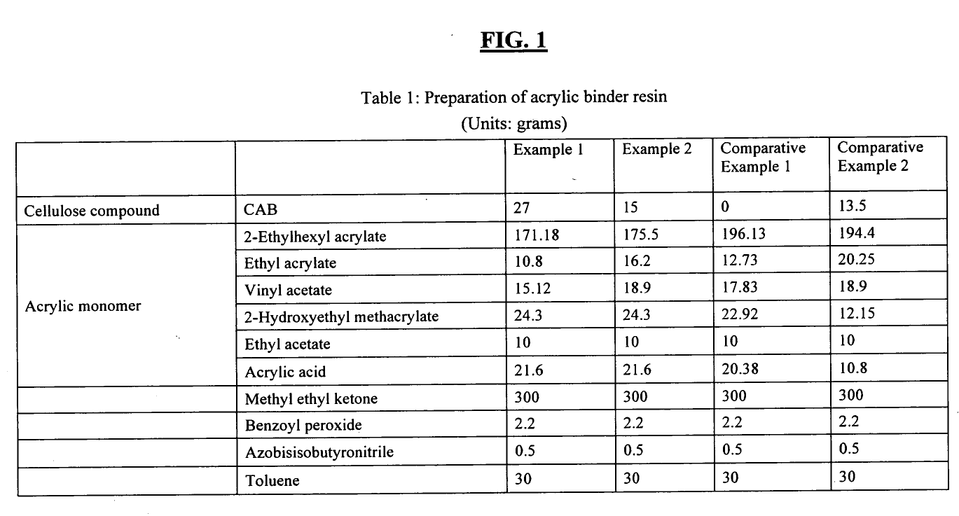

Reagents were put into a 1 L four-neck flask according to the mixture given in Table 1 of FIG. 1. The process of reacting the reagents was as follows. First, 300 g of methyl ethyl ketone and 30 g of toluene were put into the four-neck flask as solvent. The four-neck flask was provided with a reflux condenser at one side thereof, a thermometer at another side thereof, and a dropping funnel at another side thereof.

The temperature of the four-neck flask was increased to 60° C. Subsequently, 171.18 g of 2-ethylhexyl acrylate, 10.8 g of ethyl acrylate, 15.12 g of vinyl acetate, 24.3 g of 2-hydroxyethyl methacrylate, 21.6 g of acrylic acid, and 27 g of cellulose acetate butyrate (manufactured by Eastman Corp.; hereinafter referred to as “CAB”) were mixed with 2.2 g of benzoyl peroxide to form a mixed solution, and then the mixed solution was dropped at a temperature of 60° C. to 70° C. for 3 hours using the dropping funnel.

The agitation speed at the time of the dropping of the mixed solution was 250 rpm. After the mixed solution was completely dropped, the reaction product was aged at the same temperature for 4 hours, 10 g of ethyl acetate and 0.5 g of azobisisobutyronitrile (AIBN) were added to the reaction product, and then the reaction product was maintained for 4 hours. Subsequently, the solid content of the reaction product was measured, and then the reaction was stopped, thereby preparing an acrylic binder resin (an acrylic copolymer). After the polymerization, the prepared acrylic binder resin had a viscosity of 15,000 cps to 20,000 cps, and the amount of the solid content thereof was compensated to 45%.

### EXAMPLE 2

### Preparation of Acrylic Binder Resin

As indicated in Table 1, an acrylic binder resin was prepared as in Example 1, except that, as a composition of an acrylic monomer, 175.5 g of 2-ethylhexyl acrylate, 16.2 g of ethyl acrylate, 18.9 g of vinyl acetate, 24.3 g of 2-hydroxyethyl methacrylate, and 21.6 g of acrylic acid were used, and the amount of CAB used was 15 g.

### COMPARATIVE EXAMPLE 1

### Preparation of Acrylic Binder Resin

As indicated by the composition and amounts given in Table 1, an acrylic binder resin was prepared as in Example 1, except that CAB was not used.

### COMPARATIVE EXAMPLE 2

### Preparation of Acrylic Binder Resin

As indicated by the composition and amounts given in Table 1, an acrylic binder resin was prepared as in Example 1, except that 13.5 g of CAB was used.

### EXAMPLE 3

### Preparation of Photocurable Pressure-Sensitive Adhesive Composition

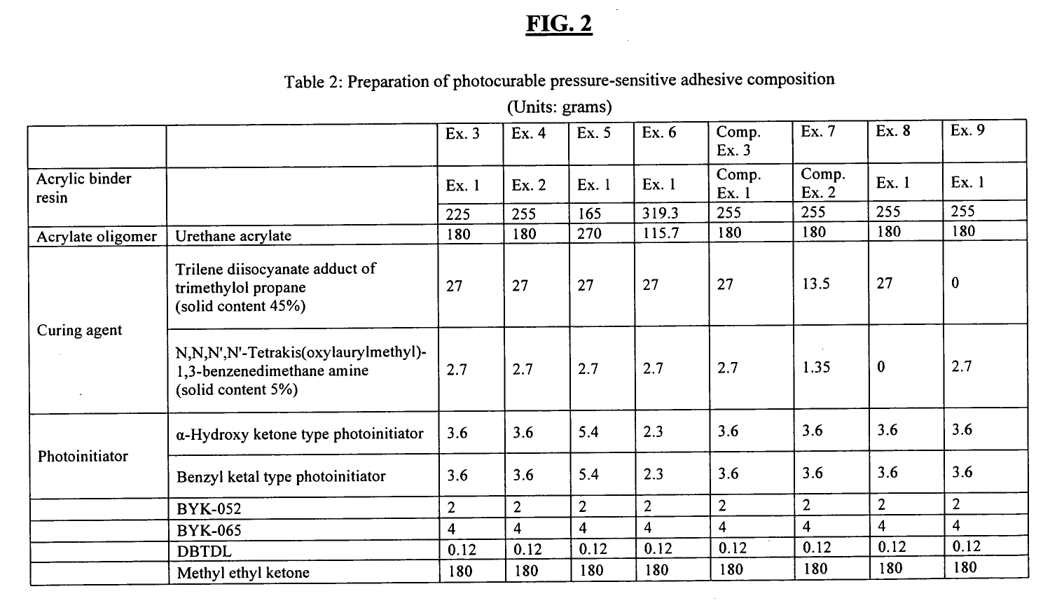

A photocurable pressure-sensitive adhesive composition was prepared using the acrylic binder resin prepared in Example 1 through a commonly-used method, in the composition and amounts given in Table 2 of FIG. 2. In Table 2, BYK-052 and BYK-065 are antifoaming agents, and DBTDL is a urethane catalyst.

### EXAMPLE 4

### Preparation of Photocurable Pressure-Sensitive Adhesive Composition

As indicated by the composition and amounts given in Table 2, a photocurable pressure-sensitive adhesive composition was prepared as in Example 3, except that the acrylic binder resin prepared in Example 2 was used.

### EXAMPLE 5

### Preparation of Photocurable Pressure-Sensitive Adhesive Composition

As indicated by the composition and amounts given in Table 2, a photocurable pressure-sensitive adhesive composition was prepared as in Example 3, except that the acrylic binder resin prepared in Example 1 was used.

### EXAMPLE 6

### Preparation of Photocurable Pressure-Sensitive Adhesive Composition

As indicated by the composition and amounts given in Table 2, a photocurable pressure-sensitive adhesive composition was prepared as in Example 3, except that the acrylic binder resin prepared in Example 1 was used.

### COMPARATIVE EXAMPLE 3

### Preparation of Photocurable Pressure-Sensitive Adhesive Composition

As indicated by the composition and amounts given in Table 2, a photocurable pressure-sensitive adhesive composition was prepared as in Example 3, except that the acrylic binder resin prepared in Comparative Example 1 was used.

### EXAMPLE 7

### Preparation of Photocurable Pressure-Sensitive Adhesive Composition

As indicated by the composition and amounts given in Table 2, a photocurable pressure-sensitive adhesive composition was prepared as in Example 3, except that the acrylic binder resin prepared in Comparative Example 2 was used.

### EXAMPLE 8

### Preparation of Photocurable Pressure-Sensitive Adhesive Composition

As indicated by the composition and amounts given in Table 2, a photocurable pressure-sensitive adhesive composition was prepared as in Example 3, except that the acrylic binder resin prepared in Example 1 was used.

### EXAMPLE 9

### Preparation of Photocurable Pressure-Sensitive Adhesive Composition

As indicated by the composition and amounts given in Table 2, a photocurable pressure-sensitive adhesive composition was prepared as in Example 3, except that the acrylic binder resin prepared in Example 1 was used.

### TEST EXAMPLE 1

### Measurement of Initial Adhesivity of Photocurable Pressure-Sensitive Adhesive Composition

In order to test the material properties of the photocurable pressure-sensitive adhesive composition of example embodiments, the photocurable pressure-sensitive adhesive compositions prepared in Examples 3-9 were applied on a PET film and then dried to form a coated film having a thickness of about 5 μm to about 8 μm. Subsequently, the coated film was transferred to a polyolefin film and aged at a temperature of about 25° C. to about 60° C. for about 4 to about 7 days, and then the adhesivity of the photocurable pressure-sensitive adhesive compositions was measured.

The measurements of the adhesivity of the photocurable pressure-sensitive adhesive compositions were conducted based on Section 3 of Korean Standards, KS-A-01107 (test method of adhesive tape and adhesive sheet). A sample having a width of 25 mm and a length of 250 mm was attached to a stainless steel plate (SUS #27), and was then pressed one time at a speed of 300 mm/min using a pressing roller having a load of 2 Kg to fabricate a test piece. 30 minutes after the sample was pressed, the folded portion of the test piece was turned over at an angle of 180°, and 25 mm of the thickness of the test piece was peeled. Thereafter, the test piece was fixed on a clip located over a tension tester, and the stainless steel plate (SUS #27) was fixed on a clip located under the tension tester, and then they were drawn and peeled. At this time, the load of the tension tester was measured.

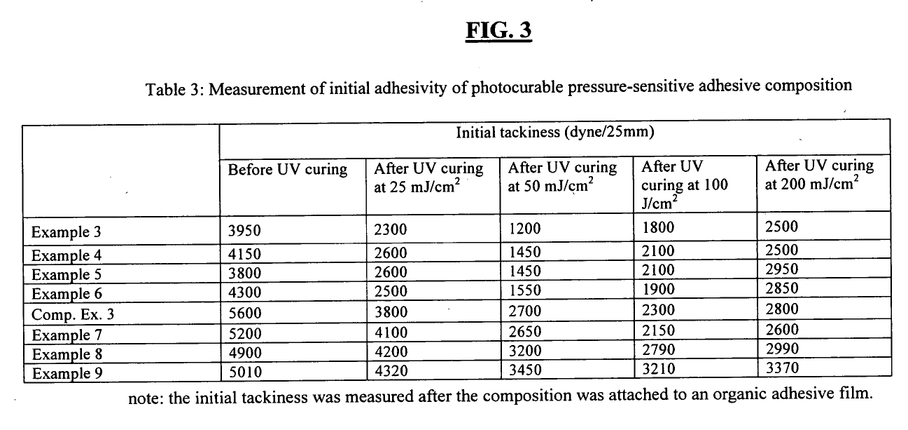

An Instron Series IX/s Automated Materials Tester-3343 was used as the tension tester. After an organic adhesive film or a wafer was attached to the photocurable pressure-sensitive adhesive film, the adhesivity of the photocurable pressure-sensitive adhesive compositions was measured before and after exposure using a high-pressure mercury lamp having a luminosity variable from 25 mJ/cm² to 200 mJ/cm². The results thereof are given in Table 3 of FIG. 3.

### TEST EXAMPLE 2

### Measurement of Tackiness of Photocurable Pressure-Sensitive Adhesive composition

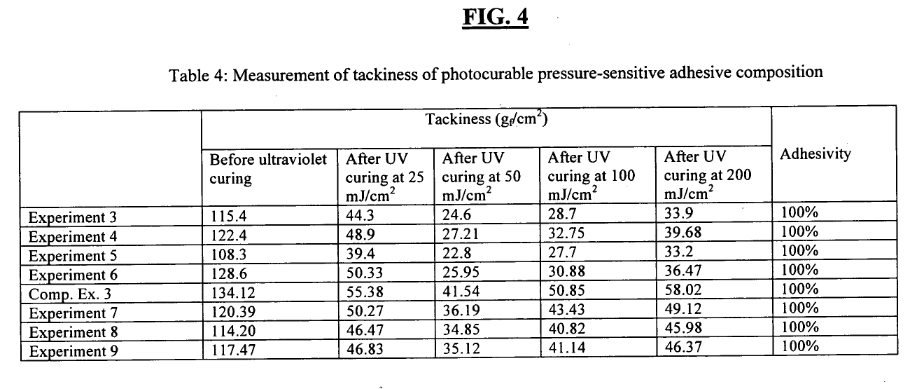

The tackiness of the photocurable pressure-sensitive adhesive composition was measured using the test piece fabricated in Test Example 1 and a probe tack tester (Tacktoc-2000). The results thereof are given in Table 4 of FIG. 4.

In the measurement method, tackiness was defined as the maximum force required when the clean tip of a probe was brought into contact with a pressure-sensitive adhesive at a speed of 10±0.1 mm/sec and at a contact load of 9.79±1.01 kPa for 1.0±0.01 seconds based on ASTM D2979-71, and then separated therefrom.

### TEST EXAMPLE 3

### Measurement of Adhesivity of Photocurable Pressure-Sensitive Adhesive Composition

11 lines were horizontally and vertically drawn on a coated film at 1 mm intervals by a sharp cutter using a cross cut tester to fabricate a baduk board having 100 speckled patterns, using the test piece fabricated in Test Example 1. Subsequently, an adhesive tape was attached on the baduk board, and was then instantaneously pulled, thus measuring the adhesivity of the photocurable pressure-sensitive adhesive composition. The results thereof are given in Table 4.

As shown in Tables 3 and 4, comparing the measured results according to UV exposure, it can be seen that the photocurable pressure-sensitive adhesive composition exhibits the best peel strength and tackiness at an exposure of 50 mJ/cm². In Examples 3-6, it can be seen that, in the compositions that include CAB, the differences between tackiness before photocuring and tackiness after photocuring are significant. According to the above results, example embodiments may provide a photocurable pressure-sensitive adhesive composition that exhibits excellent material properties even at low exposures to curing radiation, which may be particularly suitable for use as a film for dicing.

In contrast, in Comparative Example 3, it can be seen that, in the composition that does not include CAB, the peel strength and tackiness thereof after photocuring are relatively poor as compared to Example 3. In Examples 7-9, in the case where the amount and composition ratio of the epoxy curing agent and an isocyanate curing agent used in Example 3 are changed, it can be seen that the peel strength and tackiness thereof after photocuring are not as good as those in Example 3.

As described above, example embodiments may provide a photocurable pressure-sensitive adhesive composition including an acrylic binder resin, which may be obtained by modifying acrylic monomers with cellulose compounds. The photocurable pressure-sensitive adhesive composition may exhibit excellent initial adhesivity, may have a high peel strength even in a relatively low molecular weight of about 150,000 to about 200,000, and may have excellent photocurability and good change in peel strength because it has low surface energy after photocuring. Therefore, the composition may be useful for an adhesive tape for dicing, die bonding, etc., requiring low peel strength after photocuring.

Exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A photocurable pressure-sensitive adhesive composition, comprising:
an acrylic binder resin including a cellulose compound and an acrylic monomer;
an acrylate oligomer compound;
a curing agent; and
a photoinitiator.

2. The photocurable pressure-sensitive adhesive composition as claimed in claim 1, wherein the composition comprises, based on solid content:
about 35% to about 65% by weight of the acrylic binder resin;
about 25% to about 60% by weight of the acrylate oligomer compound;
about 1% to about 20% by weight of the curing agent; and
about 1% to about 5% by weight of the photoinitiator.

3. The photocurable pressure-sensitive adhesive composition as claimed in claim 1, wherein:
the acrylic binder resin is a copolymer of the cellulose compound and the acrylic monomer,
the acrylic binder resin includes about 5% to about 20% by weight of the cellulose compound, based on the weight of the acrylic binder resin, and
the acrylic binder resin includes about 80% to about 95% by weight of the acrylic monomer, based on the weight of the acrylic binder resin.

4. The photocurable pressure-sensitive adhesive composition as claimed in claim 3, wherein the cellulose compound includes one or more of cellulose acetate butyrate, cellulose acetate propionate, carboxymethyl cellulose, hydroxymethyl cellulose, triacetyl cellulose, hydroxyethyl cellulose, hydroxypropyl cellulose, hydroxypropyl methyl cellulose, ethane cellulose, or nitrocellulose.

5. The photocurable pressure-sensitive adhesive composition as claimed in claim 4, wherein the cellulose compound has an acetyl amount of about 2% to about 30% by weight.

6. The photocurable pressure-sensitive adhesive composition as claimed in claim 4, wherein the cellulose compound has a hydroxy number of about 20 to about 150, a glass transition temperature of about 85° C. to about 130° C., and a weight-average molecular weight of about 1,200 to about 70,000.

7. The photocurable pressure-sensitive adhesive composition as claimed in claim 4, wherein the cellulose compound includes cellulose acetate butyrate, and the cellulose acetate butyrate has a butyryl amount of about 17% to about 53% by weight of the cellulose acetate butyrate.

8. The photocurable pressure-sensitive adhesive composition as claimed in claim 3, wherein the acrylic monomer includes one or more of a carboxylic monomer, a hydroxy monomer, a functional monomer, a soft acrylic monomer, or a hard acrylic monomer.

9. The photocurable pressure-sensitive adhesive composition as claimed in claim 8, wherein the acrylic monomer includes:
(1) the carboxylic monomer, and the carboxylic monomer includes one or more of methacrylic acid, itaconic acid, maleic acid, or fumaric acid; or
(2) the hydroxy monomer, and the hydroxy monomer includes one or more of 2-hydroxyethyl methacrylate, hydroxyethyl acrylate, hydroxybutyl acrylate, hydroxypropyl (meth)acrylate, or vinyl caprolactam; or
(3) the functional monomer, and the functional monomer includes one or more of dimethylaminoethyl methacrylate, t-butylaminoethyl methacrylate, diethylaminoethyl methacrylate, or glycidyl methacrylate; or
(4) the soft acrylic monomer, and the soft acrylic monomer includes one or more of 2-ethylhexyl methacrylate, lauryl methacrylate, methyl acrylate, ethyl acrylate, n-butyl acrylate, isobutyl acrylate, 2-ethylhexyl acrylate, or octadecyl methacrylate; or
(5) the hard acrylic monomer, and the hard acrylic monomer includes one or more of methyl methacrylate, styrene, cyclohexyl methacrylate, methacrylate, isobornyl methacrylate, glycidyl methacrylate, n-butyl methacrylate, isobutyl methacrylate, t-butyl methacrylate, vinyl chloride, vinyl acetate, or acrylonitrile.

10. The photocurable pressure-sensitive adhesive composition as claimed in claim 1, wherein the acrylic binder resin has a hydroxy number of about 20 about 40, an acid number of about 60 to about 95, a glass transition temperature of about −70° C. to about −50° C., and a weight-average molecular weight of about 150,000 to about 200,000.

11. The photocurable pressure-sensitive adhesive composition as claimed in claim 1, wherein the acrylate oligomer compound includes one or more of a urethane acrylate oligomer and an epoxy acrylate oligomer.

12. The photocurable pressure-sensitive adhesive composition as claimed in claim 11, wherein the acrylate oligomer compound includes:
(1) the urethane acrylate oligomer, and the urethane acrylate oligomer has a weight-average molecular weight of about 500 to about 5000 and a functional group number of about 3 to about 8; or
(2) the epoxy acrylate oligomer, and the epoxy acrylate oligomer has a weight-average molecular weight of about 500 or less and a functional group number of 1 to about 4.

13. The photocurable pressure-sensitive adhesive composition as claimed in claim 1, wherein the curing agent includes one or more of polyisocyanate and a multi-functional epoxy compound.

14. The photocurable pressure-sensitive adhesive composition as claimed in claim 13, wherein the curing agent includes:
(1) the polyisocyanate, and the polyisocyanate includes one or more of 2,4-trilene diisocyanate, 2,6-trilene diisocyanate, hydrogenated trilene diisocyanate, 1,3-xylene diisocyanate, 1,4-xylene diisocyanate, diphenyl methane-4,4-diisocyanate, 1,3-bisisocyanatomethyl cyclohexane, tetramethyl xylene diisocyanate, 1,5-naphthalene diisocyanate, 2,2,4-trimethyl hexamethylene diisocyanate, 2,4,4-trimethyl hexamethylene diisocyanate, a trilene diisocyanate adduct of trimethylol propane, a xylene diisocyanate adduct of trimethylol propane, triphenylmethane triisocyanate, or methylene bis triisocyanate; or
(2) the multi-functional epoxy compound, and the multi-functional epoxy compound includes one or more of a bisphenol A-epichlorohydrin type epoxy resin, an epoxy compound, an azide compound, or a melamine compound.

15. The photocurable pressure-sensitive adhesive composition as claimed in claim 14, wherein the multi-functional epoxy compound includes:
(1) the epoxy compound, and the epoxy compound includes one or more of ethylene glycol diglycidyl ether, polyethylene glycol diglycidyl ether, glycerin diglycidyl ether, glycerin triglycidyl ether, 1,6-hexanediol diglycidyl ether, trimethylolpropane triglycidyl ether, sorbitol polyglycidyl ether, polyglycerol polyglycidyl ether, pentaerythritol polyglycidyl ether, or diglycerol polyglycidyl ether; or
(2) the azide compound, and the azide compound includes one or more of tetramethylolmethane-tri-β-aziridinylpropionate, trimethylolpropane-tri-β-aziridinylpropionate, N,N′-diphenylmethane-4,4′-biscarboxyamide, N,N′-hexamethylene-1,6-biscarboxyamide, or N,N,N′,N′-tetrakis(oxylaurylmethyl)-1,3-benzenedimethane amine; or
(3) the melamine compound, and the melamine compound includes one or more of hexamethoxymethyl melamine, hexaethoxymethyl melamine, hexapropoxymethyl melamine, hexabutoxymethyl melamine, hexapentyloxymethyl melamine, or hexahexyloxymethyl melamine.

16. The photocurable pressure-sensitive adhesive composition as claimed in claim 1, wherein the curing agent comprises about 5% to about 15% by weight of polyisocyanate and about 1% to about 5% by weight of a multi-functional epoxy compound, based on the weight of the curing agent.

17. The photocurable pressure-sensitive adhesive composition as claimed in claim 1, wherein the photoinitiator includes a mixture of an alpha-hydroxy ketone type compound and a benzylketal type compound.

18. The photocurable pressure-sensitive adhesive composition as claimed in claim 17, wherein the alpha-hydroxy ketone type compound has a melting point of about 45° C. to about 49° C., and the benzylketal type compound has a melting point of about 64° C. to about 67° C.

19. An adhesive tape comprising the photocurable pressure-sensitive composition as claimed in claim 1.

20. The adhesive tape as claimed in claim 19, wherein the adhesive tape is incorporated into a dicing film, a die bonding film, or a dicing die bonding film.
